(19) United States
(12) Patent Application Publication
(10) Pub. No.: US 2024/0214692 A1
(43) Pub. Date: Jun. 27, 2024

(54) HIGH DYNAMIC RANGE REGION BASED COMPUTE GATING

(71) Applicant: QUALCOMM Incorporated, San Diego, CA (US)

(72) Inventors: Abhijeet DEY, Bengaluru (IN); Joby ABRAHAM, Bangalore (IN); Animesh BEHERA, Bengaluru (IN); Debarati KUNDU, Bangalore (IN)

(21) Appl. No.: 18/146,861

(22) Filed: Dec. 27, 2022

(51) Int. Cl. H04N 23/82; G06T 5/00; G06T 5/50

(52) U.S. Cl. CPC H04N 23/82; G06T 5/007; G06T 5/50; G06T 2207/20208; G06T 2207/20221; G06T 2207/30168

(57) ABSTRACT

Techniques are described herein for processing image data. For instance, a technique can include obtaining a first image having a first exposure time and a second image having a second exposure time, the second exposure time greater than the first exposure time; determining at least one of: that one or more pixels of the first image has a pixel value below a first threshold value; or that one or more pixels of the second image has a pixel value above a second threshold value; preventing image processing on the one or more pixels based on the determination; replacing, based on preventing image processing on the one or more pixels, one or more pixel values of the one or more pixels with one or more replacement pixel values; and outputting the first or the second image, the first or the second image including the one or more replacement pixel values.

### TECHNICAL FIELD

The present disclosure generally relates to image processing. For example, aspects of the present disclosure relate to systems and techniques for performing high dynamic range region-based compute gating, which can reduce power and bandwidth used by an image processing system when generating images, such as high dynamic range (HDR) images and/or other images.

### BACKGROUND

A camera is a device that receives light and captures image frames, such as still images or video frames, using an image sensor. Cameras may include one or more processors, such as image signal processors (ISPs), that can process one or more image frames captured by an image sensor. For example, a raw image frame captured by an image sensor can be processed by an image signal processor (ISP) to generate a final image. Cameras can be configured with a variety of image capture and image processing settings to alter the appearance of an image. Some camera settings are determined and applied before or while an image is captured, such as ISO, exposure time (also referred to as exposure duration), aperture size, f/stop, shutter speed, focus, and gain, among others. Moreover, some camera settings can be configured for post-processing of an image, such as alterations to a contrast, brightness, saturation, sharpness, levels, curves, and colors, among others.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for reducing a power and bandwidth used by an image processing system to generate a high dynamic range image. According to at least one example, an apparatus for processing image data is provided. The apparatus includes a memory and one or more processors coupled to the memory. The one or more processors are configured to: obtain a first image having a first exposure time and a second image having a second exposure time, wherein the second exposure time is greater than the first exposure time; determine at least one of: that one or more pixels of the first image has a pixel value below a first threshold value: or that one or more pixels of the second image has a pixel value above a second threshold value: prevent image processing on the one or more pixels based on the determination: replace, based on preventing image processing on the one or more pixels, one or more pixel values of the one or more pixels with one or more replacement pixel values: and output the first image or the second image, the first image or the second image including the one or more replacement pixel values.

As another example, an apparatus for processing image data. The apparatus includes a memory: and one or more processors coupled to the memory, the one or more processors are configured to: obtain, for an image, a first pixel value: store the first pixel value in the memory as a replacement pixel value: obtain, for the image, a second pixel value: determine that the second pixel value is within a threshold pixel value of the first pixel value: prevent image processing on a pixel associated with the second pixel value based on the determination: replace the second pixel value of the pixel with the replacement pixel value: and output the image, the image including the replacement pixel value for the pixel.

In another example, a method for processing image data is provided. The method includes: obtaining a first image having a first exposure time and a second image having a second exposure time, wherein the second exposure time is greater than the first exposure time; determining at least one of: that one or more pixels of the first image has a pixel value below a first threshold value: or that one or more pixels of the second image has a pixel value above a second threshold value: preventing image processing on the one or more pixels based on the determination: replacing, based on preventing image processing on the one or more pixels, one or more pixel values of the one or more pixels with one or more replacement pixel values: and outputting the first image or the second image, the first image or the second image including the one or more replacement pixel values.

As another example, a method for processing image data is provided. The method includes: obtaining, for an image, a first pixel value: storing the first pixel value as a replacement pixel value: obtaining, for the image, a second pixel value: determining that the second pixel value is within a threshold pixel value of the first pixel value: preventing image processing on a pixel associated with the second pixel value based on the determination; replacing the second pixel value of the pixel with the replacement pixel value: and outputting the image, the image including the replacement pixel value for the pixel.

In another example, a non-transitory computer-readable medium is provided that has stored thereon instructions that, when executed by at least one processor, cause the at least one processor to: obtain a first image having a first exposure time and a second image having a second exposure time, wherein the second exposure time is greater than the first exposure time; determine at least one of: that one or more pixels of the first image has a pixel value below a first threshold value: or that one or more pixels of the second image has a pixel value above a second threshold value: prevent image processing on the one or more pixels based on the determination: replace, based on preventing image processing on the one or more pixels, one or more pixel values of the one or more pixels with one or more replacement pixel values: and output the first image or the second image, the first image or the second image including the one or more replacement pixel values.

In another example, a non-transitory computer-readable medium is provided that has stored thereon instructions that, when executed by at least one processor, cause the at least one processor to: obtain, for an image, a first pixel value: store the first pixel value in the memory as a replacement pixel value: obtain, for the image, a second pixel value: determine that the second pixel value is within a threshold pixel value of the first pixel value: prevent image processing on a pixel associated with the second pixel value based on the determination: replace the second pixel value of the pixel with the replacement pixel value: and output the image, the image including the replacement pixel value for the pixel.

As another example, an apparatus is provided. The apparatus includes means for obtaining a first image having a first exposure time and a second image having a second exposure time, wherein the second exposure time is greater than the first exposure time: means for determining at least one of: that one or more pixels of the first image has a pixel value below a first threshold value: or that one or more pixels of the second image has a pixel value above a second threshold value: means for preventing image processing on the one or more pixels based on the determination: means for replacing, based on preventing image processing on the one or more pixels, one or more pixel values of the one or more pixels with one or more replacement pixel values: and means for outputting the first image or the second image, the first image or the second image including the one or more replacement pixel values.

In another example, an apparatus is provided. The apparatus includes means for obtaining, for an image, a first pixel value: storing the first pixel value as a replacement pixel value: means for obtaining, for the image, a second pixel value: determining that the second pixel value is within a threshold pixel value of the first pixel value: means for preventing image processing on a pixel associated with the second pixel value based on the determination: means for replacing the second pixel value of the pixel with the replacement pixel value: and means for outputting the image, the image including the replacement pixel value for the pixel.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a mobile device (e.g., a mobile telephone or so-called “smart phone” or other mobile device), a wearable device, a personal computer, a laptop computer, a tablet computer, a server computer, a robotics device or system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image processing system, in accordance with some examples of the present disclosure:

FIG. 2 illustrates multiple images with different exposures used to create a fused high dynamic range image, in accordance with some examples of the present disclosure:

FIG. 3 is a block diagram illustrating an example system for generating an HDR image 350, in accordance with aspects of the present disclosure:

FIG. 4 is a block diagram illustrating another example system for generating an HDR image, in accordance with aspects of the present disclosure:

FIG. 5 is a block diagram illustrating an example system reducing the power and bandwidth used to generate an HDR image, in accordance with aspects of the present disclosure:

FIG. 6 is a block diagram illustrating an example system for reducing the power and bandwidth used to generate an HDR image, in accordance with aspects of the present disclosure:

FIG. 7 is a diagram of an example circuit for gating pixel values and processing gated pixel values, in accordance with aspects of the present disclosure;

FIG. 8 is a diagram of an example compute gate engine for a configurable pixel value gating and processing, in accordance with aspects of the present disclosure

FIG. 9 is a flow diagram for a process for processing image data, in accordance with aspects of the present disclosure:

FIG. 10 is a flow diagram for processing image data, in accordance with aspects of the present disclosure:

FIG. 11 illustrates an example computing device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.) are increasingly equipped with camera hardware to capture image frames, such as still images and/or video frames, for consumption. For example, an electronic device can include a camera to allow the electronic device to capture a video or image of a scene, a person, an object, etc. A camera is a device that receives light and captures image frames (e.g., still images or video frames) using an image sensor. In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, an electronic device implementing a camera can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Moreover, cameras can be configured with a variety of image capture and image processing settings to alter the appearance of an image. Some camera settings can be determined and applied before or while an image is captured, such as ISO, exposure time (also referred to as exposure duration), aperture size, f/stop, shutter speed, focus, and gain, among others. Some camera settings can be configured for post-processing of an image, such as alterations to a contrast, brightness, saturation, sharpness, levels, curves, and colors, among others. In some examples, a camera can be configured with certain settings to adjust the exposure of an image captured by the camera.

In photography, the exposure of an image captured by a camera refers to the amount of light per unit area that reaches a photographic film, or in modern cameras, an electronic image sensor. The exposure is based on certain camera settings such as, for example, shutter speed, exposure time, and/or lens aperture, as well as the luminance of the scene being photographed. Many cameras are equipped with an automatic exposure or “auto exposure” mode, where the exposure settings (e.g., shutter speed, exposure time, lens aperture, etc.) of the camera may be automatically adjusted to match, as closely as possible, the luminance of a scene or subject being photographed. In some cases, an automatic exposure control (AEC) engine can perform AEC to determine exposure settings for an image sensor.

In photography and videography, a technique called high dynamic range (HDR) allows the dynamic range of image frames captured by a camera to be increased beyond the native capability of the camera. In this context, a dynamic range refers to the range of luminosity between the brightest area and the darkest area of the scene or image frame. For example, a high dynamic range means there is a lot of variation in light levels within a scene or an image frame. HDR can involve capturing multiple image frames of a scene with different exposures and combining captured image frames with the different exposures into a single image frame. The combination of image frames with different exposures can result in an image with a dynamic range higher than that of each individual image frame captured and combined to form the HDR image frame. For example, the electronic device can create a high dynamic range scene by fusing two or more exposure frames into a single frame. HDR is a feature often used by electronic devices, such as smartphones and mobile devices, for various purposes. For example, in some cases, a smartphone can use HDR to achieve a better image quality or an image quality similar to the image quality achieved by a digital single-lens reflex (DSLR) camera.

In some examples, the electronic device can create an HDR image using multiple image frames with different exposures. For example, the electronic device can create an HDR image using a short exposure (SE) image, a medium exposure (ME) image, and a long exposure (LE) image. As another example, the electronic device can create an HDR image using an SE image and an LE image. In some cases, the electronic device can write the different image frames from camera frontends to a memory device, such as a double data rate (DDR) synchronous dynamic random-access memory (SDRAM) or any other memory device. A processing engine can then retrieve the image frames to fuse the image frames into a single image. However, the different write and read operations used to create the HDR image can result in significant power and bandwidth consumption.

Generally, the over-exposed pixels of long exposure images and under-exposed pixels of short exposure images do not contribute to the final fused image (e.g., the HDR image) produced by the HDR algorithm. Nevertheless, the over-exposed pixels of long exposure images and under-exposed pixels of short exposure images are still written from the camera frontend to the memory device and read back from the memory device by the processing engine. Thus, the operations to read and write the over-exposed pixels of long exposure images and under-exposed pixels of short exposure images contribute to the power and bandwidth consumption of the electronic device even though such pixels do not contribute to the final fused image.

In some cases, images may have portions which includes pixels that have substantially the same value. For example, a portion of an image may include a clear blue sky and multiple pixels of this clear blue sky may be substantially similar. These small differences in pixel values between neighboring pixels may be difficult to recognize to the human eye. Additionally, images may be processed using various detection/recognition algorithms, and such small differences in neighboring pixels may not play a significant role in such tasks. In some cases, it may be useful to reduce an amount of image processing for such images.

Systems, apparatuses, methods (also referred to as processes), and computer-readable media (collectively referred to herein as “systems and techniques”) are described herein for performing high dynamic range region-based compute gating to prevent image processing on one or more pixels. The systems and techniques described herein can reduce power and bandwidth consumption when creating an HDR image. For instance, the systems and techniques can optimize the HDR algorithm and reduce the power and bandwidth consumption when creating an HDR image. In some cases, the systems and techniques can reduce the power and bandwidth consumption when creating an HDR image by removing redundant pixel information and/or pixel information that does not contribute towards the final output when creating an HDR image.

In some cases, the systems and techniques herein can gate pixels (e.g., by preventing image processing on the pixels) which do not contribute to the final fused image (e.g., HDR image or other image), such as the over-exposed pixels of a long exposure image and the under-exposed pixels of a short exposure image, or pixels that are substantially similar to neighboring pixels. The gated pixels may not be processed by one or more image processing systems or techniques that are applied to pixels that are not gated. In some cases, pixel values of the gated pixels may be replaced by a replacement value. In some cases, the replacement value may be based on a previously processed pixel value. As the gated pixels may be replaced by a same replacement pixel value, the amount of information that is compressed can reduced and/or the compression ratio can be increased. Thus, by not processing gated pixels and increasing the compression ratio for the long and/or short exposure images, the systems and techniques described herein can reduce the dynamic power usage and bandwidth used to process, store (e.g., write to memory), and retrieve (e.g., read from memory) the images for generating an image.

Various aspects of the application will be described with respect to the figures.

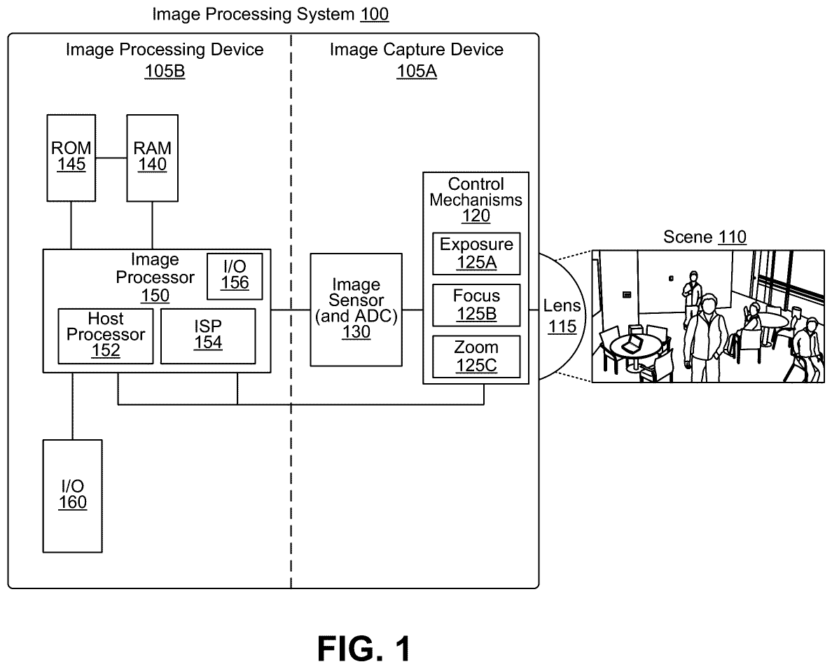

FIG. 1 is a block diagram illustrating an example architecture of an image processing system 100. The image processing system 100 includes various components that are used to capture and process images, such as an image of a scene 110. The image processing system 100 can capture image frames (e.g., still images or video frames). In some cases, the lens 115 and image sensor 130 can be associated with an optical axis. In one illustrative example, the photosensitive area of the image sensor 130 (e.g., the photodiodes) and the lens 115 can both be centered on the optical axis.

In some examples, the lens 115 of the image processing system 100 faces a scene 110 and receives light from the scene 110. The lens 115 bends incoming light from the scene toward the image sensor 130. The light received by the lens 115 then passes through an aperture of the image processing system 100. In some cases, the aperture (e.g., the aperture size) is controlled by one or more control mechanisms 120. In other cases, the aperture can have a fixed size.

The one or more control mechanisms 120 can control exposure, focus, and/or zoom based on information from the image sensor 130 and/or information from the image processor 150. In some cases, the one or more control mechanisms 120 can include multiple mechanisms and components. For example, the control mechanisms 120 can include one or more exposure control mechanisms 125A, one or more focus control mechanisms 125B, and/or one or more zoom control mechanisms 125C. The one or more control mechanisms 120 may also include additional control mechanisms besides those illustrated in FIG. 1. For example, in some cases, the one or more control mechanisms 120 can include control mechanisms for controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting the focus. In some cases, additional lenses may be included in the image processing system 100. For example, the image processing system 100 can include one or more microlenses over each photodiode of the image sensor 130. The microlenses can each bend the light received from the lens 115 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and the focus control mechanism 125B.

The exposure control mechanism 125A of the control mechanisms 120 can obtain an exposure setting. In some cases, the exposure control mechanism 125A stores the exposure setting in a memory register. Based on the exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, the image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

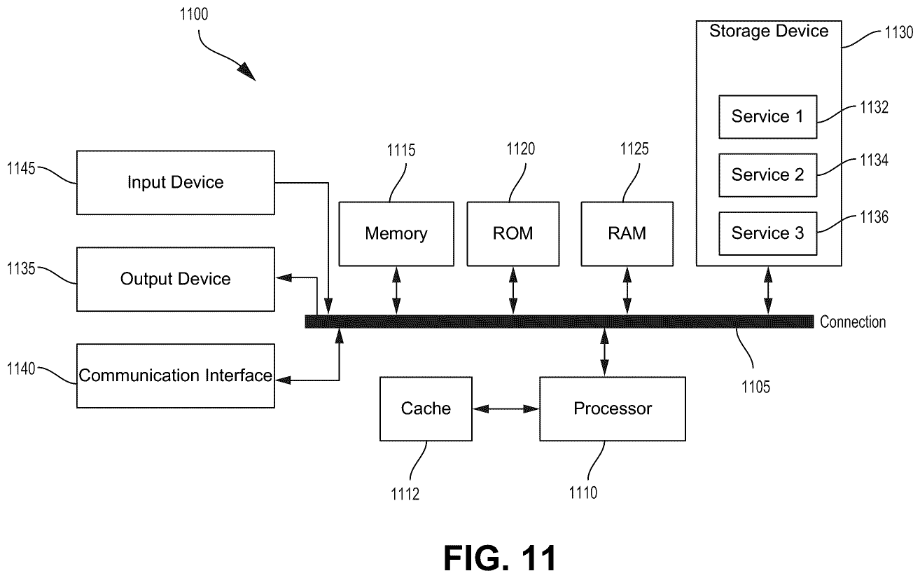

The image processor 150 may include one or more processors, such as one or more image signal processors (ISPs) (including ISP 154), one or more host processors (including host processor 152), and/or one or more of any other type of processor discussed with respect to the computing device architecture 1100 of FIG. 11. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140, read-only memory (ROM) 145, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or any combination thereof. In some cases, a caption may be input into the image processing device 105B through a physical keyboard or keypad of the I/O devices 160, or through a virtual key board or keypad of a touchscreen of the I/O devices 160. The I/O devices 160 may include one or more ports, jacks, or other connectors that enable a wired connection between the image processing system 100 and one or more peripheral devices, over which the image processing system 100 may receive data from the one or more peripheral device and/or transmit data to the one or more peripheral devices. The I/O devices 160 may include one or more wireless transceivers that enable a wireless connection between the image processing system 100 and one or more peripheral devices, over which the image processing system 100 may receive data from the one or more peripheral device and/or transmit data to the one or more peripheral devices. The peripheral devices may include any of the previously-discussed types of the I/O devices 160 and may themselves be considered I/O devices 160 once they are coupled to the ports, jacks, wireless transceivers, or other wired and/or wireless connectors.

In some cases, the image processing system 100 may be a single device. In some cases, the image processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A. In some examples, the image processing system 100 can include one or more wireless transceivers for wireless communications, such as cellular network communications, 802.11 wi-fi communications, wireless local area network (WLAN) communications, or some combination thereof.

The image processing system 100 can be part of, or implemented by, a single computing device or multiple computing devices. In some examples, the image processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, or any other suitable electronic device(s).

The image capture device 105A and the image processing device 105B can be part of the same electronic device or different electronic devices. In some implementations, the image capture device 105A and the image processing device 105B can be different devices. For instance, the image capture device 105A can include a camera device and the image processing device 105B can include a computing device, such as a mobile device, a desktop computer, a smartphone, a smart television, a game console, or other computing device.

While the image processing system 100 is shown to include certain components, one of ordinary skill will appreciate that the image processing system 100 can include more components than those shown in FIG. 1. The components of the image processing system 100 can include software, hardware, or one or more combinations of software and hardware. For example, in some implementations, the components of the image processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image processing system 100.

In some examples, the computing device architecture 1100 shown in FIG. 11 and further described below can include the image processing system 100, the image capture device 105A, the image processing device 105B, or a combination thereof.

In some examples, the image processing system 100 can create an HDR image using multiple image frames with different exposures. For example, the image processing system 100 can create an HDR image using a short exposure (SE) image, a medium exposure (ME) image, and a long exposure (LE) image. As another example, the image processing system 100 can create an HDR image using an SE image and an LE image. In some cases, the image processing system 100 can write the different image frames from one or more camera frontend engines to a memory device, such as a DDR memory device or any other memory device. A post-processing engine can then retrieve the image frames and fuse (e.g., merge, combine) them into a single image. As previously explained, the different write and read operations used to create the HDR image can result in significant power and bandwidth consumption.

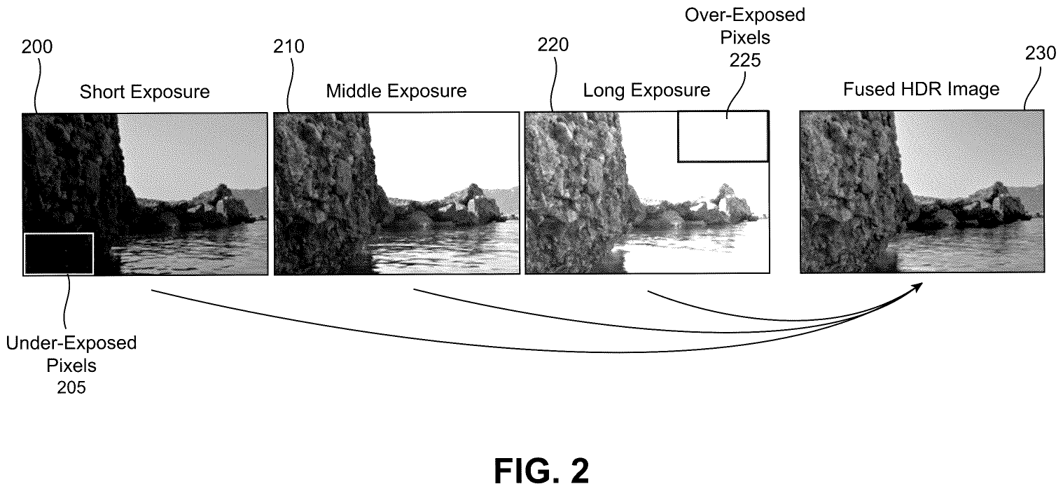

As previously explained, when creating an HDR image, over-exposed pixels of a long exposure image and under-exposed pixels of a short exposure image generally do not contribute to the final HDR image produced by the image processing system 100. For example, FIG. 2 illustrates multiple images with different exposures used to create a fused HDR image (e.g., HDR image 230). In particular, FIG. 2 shows a short exposure image 200, a medium exposure image 210, a long exposure image 220, and an HDR image 230 generated by combining or fusing together the short exposure image 200, the medium exposure image 210, and the long exposure image 220. The short exposure image 200 includes under-exposed pixels 205, and the long exposure image 220 includes over-exposed pixels 225.

As shown in FIG. 2, the under-exposed pixels 205 in the short exposure image 200 and the over-exposed pixels 225 in the long exposure image 220 do not contribute to the pixels of the HDR image 230. In some cases, when creating the HDR image 230, the image processing system 100 writes the under-exposed pixels 205 in the short exposure image 200 and the over-exposed pixels 225 in the long exposure image 220 from a camera frontend engine(s) of the image processing system 100 to a memory device, reads them back (e.g., via an offline image processing engine) from the memory device, and processes the pixels of the three images (e.g., short exposure image 200, middle exposure image 210, and long exposure image 220) to create the HDR image 230. The operations to read, write, and process the under-exposed pixels 205 in the short exposure image 200 and the over-exposed pixels 225 in the long exposure image 220 contribute to the overall power and bandwidth consumption of the image processing system 100 when creating the HDR image 230, even though such pixels do not contribute to the HDR image 230.

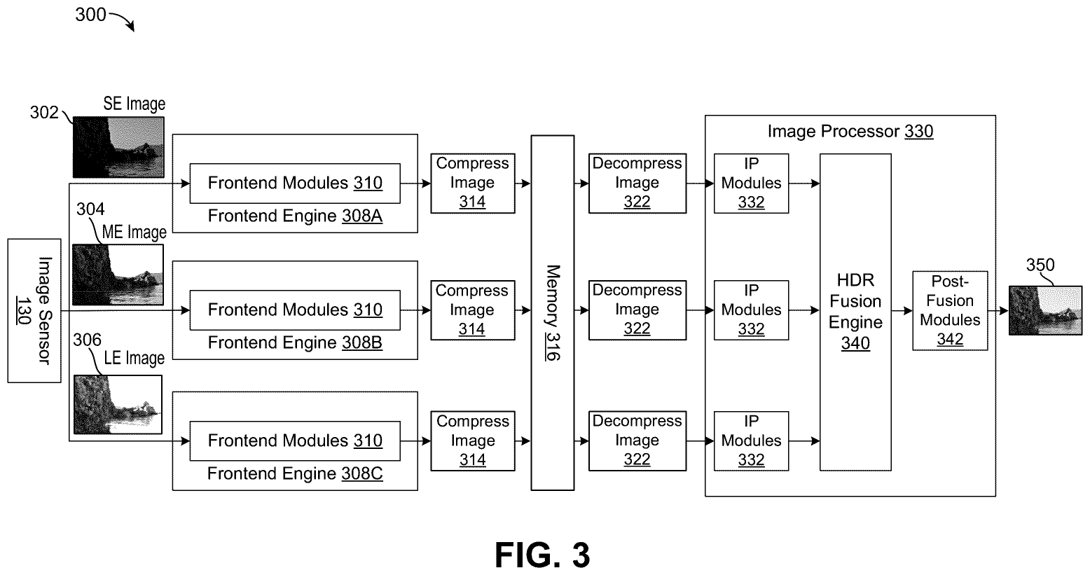

FIG. 3 is a block diagram illustrating an example system 300 for generating an HDR image 350, in accordance with aspects of the present disclosure. In this example, the system 300 generates an HDR image 350 using three images with different exposures. As shown, the image sensor 130 can capture a short-exposure (SE) image 302 of a scene, a medium-exposure (ME) image 304 of the scene, and a long-exposure (LE) image 306 of the scene. The SE image 302 can include an image with an exposure time below a threshold, the ME image 304 can include an image with an exposure time above a minimum threshold and below a maximum threshold (and/or within a range of exposure times), and the LE image 306 can include an image with an exposure time above a threshold. Moreover, the exposure time of the SE image 302 is less than the exposure time of the ME image 304, and the exposure time of the ME image 304 is less than the exposure time of the LE image 306. In this illustrative example, the camera frontend engines includes a camera frontend engine 308A for processing the SE image 302, a camera frontend engine 308B for processing the ME image 304, and a camera frontend engine 308C for processing the LE image 306.

The image sensor 130 can provide the SE image 302, the ME image 304, and the LE image 306 to the camera frontend engines 308A, 308B, 308C (collectively 308) for processing. While shown as three separate frontend engines 308, it may be understood that system 300 may utilize one camera frontend engine or multiple camera frontend engines. For example, in some cases, the camera frontend engine 308 can include a single camera frontend engine and, in other cases, the camera frontend engines 308 can include multiple camera frontend modules 310.

The camera frontend engines 308 may include one or more frontend modules 310 which can apply one or more pre-processing operations to the captured SE image 302, ME image 304, and LE image 306. While one frontend module 310 is shown per frontend engine 308, it may be understood that the frontend engines may have nay number of frontend modules 310. The pre-processing operations can include, for example and without limitation, a pixel brightness transformation (e.g., brightness correction, grey scale transformation, etc.), color space conversion, geometric transformation (e.g., rotation, scaling, translation, affine transformation, resizing, etc.), image filtering (e.g., image and/or edge smoothing and/or enhancement, denoising, image sharpening, etc.), image warping, image segmentation, image restoration, image enhancement, lens shading, color correction, black level adjustment, lens distortion correction, faulty pixel replacement, demosaicking, color balancing, compression, interpolation, any other image pre-processing operations, and/or a combination thereof.

Once pre-processed, the camera frontend engines 308 (or another component of the image processing system 100) can perform image compression 314 to compress the pre-processed SE image 302, ME image 304, and LE image 306. In some cases, the image compression 314 can include Bayer pattern compression. In some examples, the image compression 314 can include Huffman coding. In some cases, the image compression 314 can separately compresses each of the channels (e.g., red, green, and blue) of the SE image 302, the ME image 304 of the channels of the LE image 306. The compressed images may be written to memory 316. The memory 316 can include any memory device. For example, in some cases, the memory 316 can include the RAM 140 of the image processing system 100 shown in FIG. 1. In other cases, the memory 316 can include any of the memory device of computing device architecture 1100 shown in FIG. 11. In one illustrative example, the memory 316 can include a DDR memory device. In other illustrative examples, the memory 316 can include any other type of memory device.

An image processor 330 of the image processing system 100 can retrieve the compressed SE image 302, the compressed ME image 304, and the compressed LE image 306 from the memory 316 and perform image decompression 322 on the compressed SE image 302, the compressed ME image 304, and the compressed LE image 306. The image processor 330 can include one or more processors. Moreover, the image processor 330 can include any type of processors such as, for example, a CPU, a DSP, an ISP, an application-specific integrated circuit, etc. In one illustrative example, the image processor 330 can include an ISP, such as ISP 154 shown in FIG. 1.

The image processor 330 may perform one or more processing operations on the decompressed SE image 302, the decompressed ME image 304, and the decompressed LE image 306 via one or more image processing (IP) modules 332. While one IP module 332 is shown for processing each of the decompressed SE image 302, the decompressed ME image 304, and the decompressed LE image 306, it may be understood that any number of IP modules 332 may be used. The one or more processing operations can include, for example and without limitation, a filtering operation, a blending operation (e.g., blending pixel values) and/or interpolation operation, a pixel brightness transformation (e.g., brightness correction, grey scale transformation, etc.), a color space conversion, a geometric transformation (e.g., rotation, scaling, translation, affine transformation, resizing, etc.), a cropping operation, a white balancing operation, a denoising operation, an image sharpening operation, chroma sampling, image scaling, a lens correction operation, a segmentation operation, a filtering operation (e.g., filtering in terms of adjustments to the quality of the image in terms of contrast, noise, texture, resolution, etc.), an image warping operation, an image restoration operation, a lens shading operation, a lens distortion correction operation, a faulty pixel replacement operation, a demosaicking operation, a color balancing operation, a smoothing operation, an image enhancement operation, an operation for implementing an image effect or stylistic adjustment, a feature enhancement operation, an image scaling or resizing operation, a color correction operation, a black level adjustment operation, a linearization operation, a gamma correction operation, any other image post-processing operations, and/or a combination thereof.

In some cases, the image processor 330 can then perform HDR image fusion (e.g., by the HDR fusion engine 340) to fuse the decompressed SE image 302, decompressed ME image 304, and a decompressed LE image 306 into a fused HDR image. For example, the processor 330 can combine/merge the decompressed SE image 302, decompressed ME image 304, and a decompressed LE image 306 into a single, fused HDR image that has a higher dynamic range than either the SE image 302, the ME image 304, or the LE image 306.

After the HDR image fusion (e.g., by the HDR fusion engine 340), the image processor 330, in some cases, may perform post-fusion processing operations on the fused HDR image via post fusion modules 342. While one post fusion modules 342 is shown, it may be understood that any number of post fusion modules 342 may be used. The one or more post-fusion processing operations can include, for example and without limitation, a filtering operation, a blending operation (e.g., blending pixel values) and/or interpolation operation, a pixel brightness transformation (e.g., brightness correction, grey scale transformation, etc.), a color space conversion, a geometric transformation (e.g., rotation, scaling, translation, affine transformation, resizing, etc.), a cropping operation, a white balancing operation, a denoising operation, an image sharpening operation, chroma sampling, image scaling, a lens correction operation, a segmentation operation, a filtering operation (e.g., filtering in terms of adjustments to the quality of the image in terms of contrast, noise, texture, resolution, etc.), an image warping operation, an image restoration operation, a lens shading operation, a lens distortion correction operation, a faulty pixel replacement operation, a demosaicking operation, a color balancing operation, a smoothing operation, an image enhancement operation, an operation for implementing an image effect or stylistic adjustment, a feature enhancement operation, an image scaling or resizing operation, a color correction operation, a black level adjustment operation, a linearization operation, a gamma correction operation, any other image post-processing operations, and/or a combination thereof. The processor 330 may output the HDR image 350 based on the post-fusion processing operations performed on the fused HDR image.

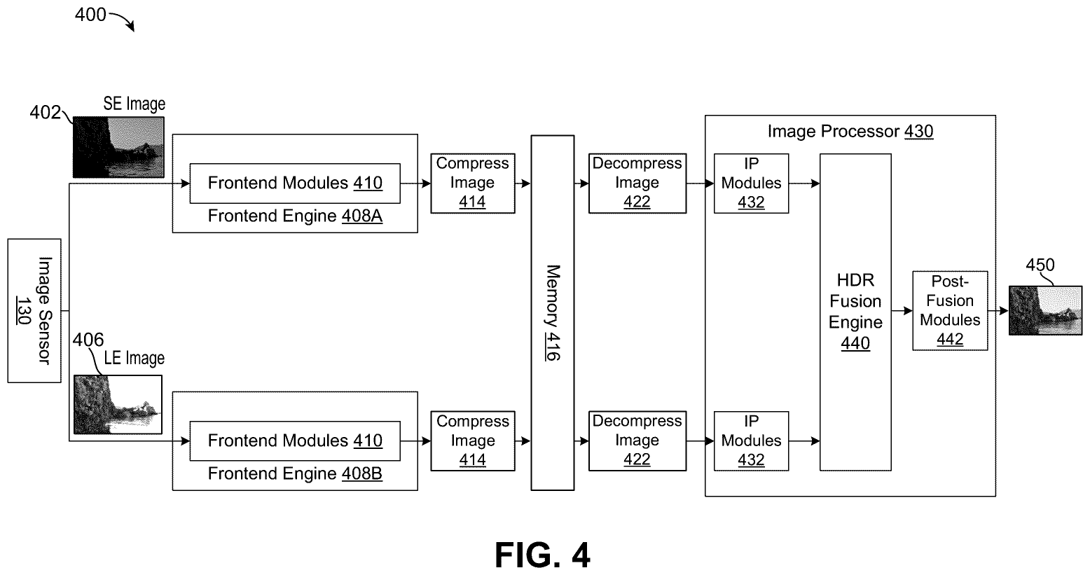

FIG. 4 is a block diagram illustrating another example system 400 for generating an HDR image 450, in accordance with aspects of the present disclosure. In this example, the system 400 generates an HDR image 450 using images with two different exposures. As shown, the image sensor 130 can capture a short-exposure (SE) image 402 of a scene and a long-exposure (LE) image 406 of the scene. In some cases, the system 400 for generating the HDR image 450 using two images is similar to the system 300 for generating the HDR image 350 using three images. In some cases, a difference in the system 400 for generating the HDR image 450 using two as compared to the system 300 for generating the HDR image 350 using three images is that the system 400 for generating the HDR image 450 does not use a medium exposure image. The SE image 402 can include an image with an exposure time below a threshold and the LE image 406 can include an image with an exposure time above a threshold.

The image sensor 130 can provide the SE image 402 and the LE image 406 to the camera frontend engines 408A, 408B (collectively 408) for processing. The camera frontend engines 408 may include one or more frontend modules 410 which can apply one or more pre-processing operations to the captured SE image 402 and LE image 406. Once pre-processed, the camera frontend engines 408 (or another component of the image processing system 100) can perform image compression 414 to compress the pre-processed SE image 402 and LE image 406. An image processor 430 of the image processing system 100 can retrieve the compressed SE image 402 and the compressed LE image 406 from the memory 416 and perform image decompression 422 on the compressed SE image 402 and the compressed LE image 406. The image processor 430 may perform one or more processing operations on the decompressed SE image 402 and the decompressed LE image 406 via one or more image processing (IP) modules 432. In some cases, the image processor 430 can then perform HDR image fusion (e.g., by the HDR fusion engine 440) to fuse the decompressed SE image 402, and a decompressed LE image 406 into a fused HDR image. After the HDR image fusion (e.g., by the HDR fusion engine 440), the image processor 330, in some cases, may perform post-fusion processing operations on the fused HDR image via post fusion modules 442. The processor 430 may output the HDR image 450 based on the post-fusion processing operations performed on the fused HDR image.

In accordance with aspects of the present disclosure, a process for creating an HDR image may be optimized to help reduce power and/or bandwidth consumption by removing redundant pixel information and/or pixel information that does not contribute towards the final output. As an example, the process for creating the HDR image may gate pixel values that do not contribute to the output HDR image, such as the under-exposed pixels 205 of FIG. 2 in the short exposure image 200 and/or the over-exposed pixels 225 in the long exposure image 220, and thus reduce the amount of information processed (e.g., compressed/decompressed, written to and read from memory, fused to create the HDR image, etc.).

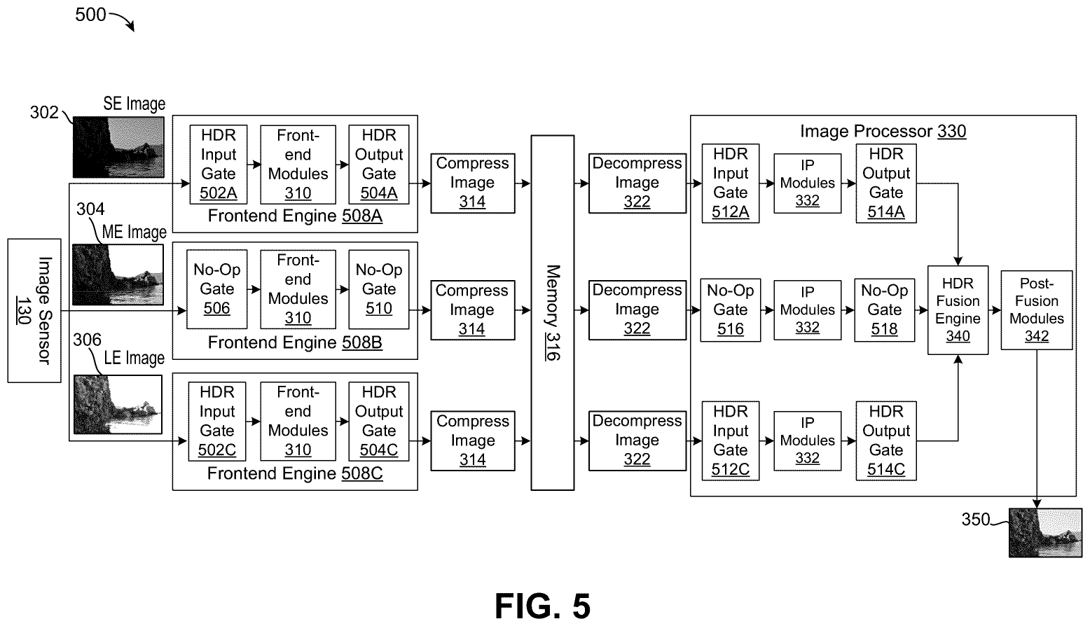

FIG. 5 is a block diagram illustrating an example system 500 reducing the power and bandwidth used to generate an HDR image 350, in accordance with aspects of the present disclosure. System 500, in this example, is similar to system 300 and the system 500 also generates an HDR image 350 using three images with different exposures. As shown, a frontend engine 508A for processing an SE image 302 and a frontend engine 508C for processing a LE image 306 may include an HDR input gate 502A and 502C (collectively 502), respectively, and an HDR output gate 504A and 504C (collectively 504), respectively. The HDR input gates 502 may be used to gate off pixel values which are redundant for generating the HDR image 350.

In some cases, an image sensor 130 can capture the SE image 302 of a scene and input the captured SE image 302 to the HDR input gate 502A of frontend engine 508A. The HDR input gate 502A may compare pixel values of the input SE image 302 against a minimum threshold value. In some cases, the minimum threshold value represents a pixel value that is so underexposed that the pixel will not contribute data towards the final HDR output (e.g., clipped or near clipped). If the pixel value is less than the minimum threshold value, the pixel may be considered underexposed and may be gated off. In some cases, the minimum threshold value may be adjustable, for example, based on capture settings of the image, such as exposure, aperture, shutter speed, image capture mode, etc. In some cases, the minimum threshold value may be adjustable per image. In some examples, the HDR input gate 502A may compare, in addition to the pixel value of a particular pixel, pixel values of neighboring pixels of the particular pixel. For example, for a first pixel with a pixel value below the minimum threshold value, N×M pixels (e.g., N×M kernel, where N and M may be any value and where N and M may be the same value) around the first pixels may also be compared against the minimum threshold value. If all N×M pixels around the first pixel are also below the minimum threshold value, then the first pixel may be in an undersaturated region and the first pixel may be gated. In some cases, the comparison of pixel values of neighboring pixels may be useful to help preserve pixel values that may be redundant for generating the HDR image 350 but may be used by processing operations that take into account neighboring pixel values.

The HDR input gate 502A may input the gated SE image 302 to one or more frontend modules 310 of frontend engine 508A which can apply one or more pre-processing operations to the gated SE image 302. In some cases, any pre-processing operation(s) may be applied to the gated SE image 302. In some cases, the one or more pre-processing operations applied in system 500 may be substantially similar to the one or more pre-processing operations applied in system 300. Where pixels are gated, the one or more pre-processing operations are not applied to the gated pixels. In some cases, after the one or more pre-processing operations are performed, a post pre-preprocessed SE image 302 may be input to the HDR output gate 504A.

In some cases, the HDR output gate 504A may replace pixel values of pixels gated by the HDR input gate 502A with replacement pixel values. In some cases, the replacement pixel values for the gated pixel values may be based on a neighboring pixel value which was not gated. In some cases, the comparison of pixel values of neighboring pixels by the HDR input gates 502 when gating pixel values may be helpful to operations of the HDR output gates 504 by ensuring that pixel values which are gated can be replaced by neighboring pixels. For example, a single pixel width line with pixel values below the minimum threshold value may be lost if pixel values of the single pixel width line are gated and replaced by pixel values from neighboring pixels if neighboring pixel values are not considered for gating pixel values. In other cases, gated pixel values may be replaced by any single value (e.g., 0) below the minimum threshold value. The HDR output gate 504A may then output the SE image 302 for image compression 314 and storage in memory 316. In some cases, areas where pixel values of the SE image 302 there were gated by the HDR input gate 502A are replaced by the same value (e.g., a neighboring value or a replacement single value) and may be more compressible by the image compression 314 and a smaller image may thus be stored in memory 316, as compared to systems (e.g., system 300), where HDR gating of pixel values is not applied.

In other cases, the HDR output gate 504A may be omitted. In such cases, pixels of the SE image 302 may be mapped (e.g., to indicate where a pixel is located in the SE image 302) and pixel values gated by HDR input gate 50A may not be included when image compression 314 is applied.

In some cases, the compressed SE image 302 may be loaded from memory 316 and image decompression 322 performed on the compressed SE image 302. The decompressed SE image 302 may be input to HDR input gate 512A. In some cases, HDR input gate 512A may be substantially similar to HDR input gate 502A and HDR input gate 512A may compare individual pixel values of the decompressed SE image 302 to the minimum threshold value or compare, in addition to the pixel value of a particular pixel, pixel values of neighboring pixels of the particular pixel to the minimum threshold value. The HDR input gate 512A may input the gated, decompressed SE image 302 to one or more image processing (IP) modules 332. In some cases, IP modules 332 of system 500 may be substantially similar to IP modules 332 of system 300. In some cases, after the one or more processing operations of IP modules 332 are performed, a post processed SE image 302 may be input to the HDR output gate 514A. In some cases, the HDR output gate 514A may be substantially similar to HDR output gate 504A. HDR output gate 514A may input to the HDR fusion engine 340. In some cases, HDR fusion engine 340 of system 500 may combine/merge the decompressed, processed SE image 302, the decompressed, processed ME image 304, and the decompressed, processed LE image 306 into a single, fused HDR image in a manner substantially similar to HDR fusion engine 340 of system 300. The fused HDR image may be input to one or more post fusion modules 342 for post-fusion processing operations. In some cases, the one or more post fusion modules 342 of system 500 may be substantially similar to one or more post fusion modules 342 of system 300. In some cases, after post processing operations, by the HDR fusion engine 340, the image processor 330 may output the HDR image 350.

In some cases, an image sensor 130 can capture the LE image 306 of a scene and input the captured LE image 306 to the HDR input gate 502C of frontend engine 508C. For the LE image 306, the HDR input gate 502C may compare pixel values of the input LE image 306 against a maximum threshold value. In some cases, the maximum threshold value represents a pixel value that is so overexposed that the pixel will not contribute data towards the final HDR output (e.g., clipped or near clipped). If the pixel value is greater than the maximum threshold value, the pixel may be considered overexposed and may be gated off. In some cases, the maximum threshold value may be adjustable, for example, based on capture settings of the image, such as exposure, aperture, shutter speed, image capture mode, etc. In some cases, the maximum threshold value may be adjustable per frame. Like the HDR input gate 502A, the HDR input gate 502C may compare individual pixel values of the input LE image 306 to the maximum threshold value or compare, in addition to the pixel value of a particular pixel, pixel values of neighboring pixels of the particular pixel to the maximum threshold value. For example, for a first pixel with a pixel value above the maximum threshold value, N×M pixels (e.g., N×M kernel, where N and M may be any value and where N and M may be the same value) around the first pixels may also be compared against the maximum threshold value. If all N×M pixels around the first pixel are also above the maximum threshold value, then the first pixel may be in an oversaturated region and the first pixel may be gated.

In some cases, the HDR input gate 502C may input the gated LE image 306 to one or more frontend modules 310 of frontend engine 508C which can apply one or more pre-processing operations to the gated LE image 306. In some cases, any pre-processing operation(s) may be applied to the gated LE image 306. In some cases, the one or more pre-processing operations applied in system 500 may be substantially similar to the one or more pre-processing operations applied in system 300. Where pixels are gated, the one or more pre-processing operations are not applied to the gated pixels. In some cases, after the one or more pre-processing operations are performed, a post pre-preprocessed LE image 306 may be input to the HDR output gate 504C. In some cases, the HDR output gate 504C may replace pixel values of pixels gated by the HDR input gate 502C with replacement pixel values in a manner substantially similar to HDR output gate 504A. The HDR output gate 504C may then output the LE image 306 for image compression 314.

In some cases, the compressed LE image 306 may be loaded from memory 316 and image decompression 322 performed on the compressed LE image 306. The decompressed LE image 306 may be input to HDR input gate 512C. In some cases, HDR input gate 512C may be substantially similar to HDR input gate 502C and may compare individual pixel values of the decompressed LE image 306 to the maximum threshold value or compare, in addition to the pixel value of a particular pixel, pixel values of neighboring pixels of the particular pixel to the maximum threshold value. The HDR input gate 512C may input the gated, decompressed LE image 306 to one or more image processing (IP) modules 332. In some cases, IP modules 332 of system 500 may be substantially similar to IP modules 332 of system 300. In some cases, after the one or more processing operations of IP modules 332 are performed, a post processed LE image 306 may be input to the HDR output gate 514C. In some cases, the HDR output gate 514C may be substantially similar to HDR output gate 504C. HDR output gate 514C may input to the HDR fusion engine 340. In some cases, HDR fusion engine 340 of system 500 may combine/merge the decompressed, processed LE image 302, the decompressed, processed ME image 304, and the decompressed, processed LE image 306 into a single, fused HDR image in a manner substantially similar to HDR fusion engine 340 of system 300. The fused HDR image may be input to one or more post fusion modules 342 for post-fusion processing operations. In some cases, the one or more post fusion modules 342 of system 500 may be substantially similar to one or more post fusion modules 342 of system 300. In some cases, after post processing operations, by the HDR fusion engine 340, the image processor 330 may output the HDR image 350.

In some examples, the minimum threshold and the maximum threshold can be configured in software. In some cases, the minimum threshold and the maximum threshold can be updated per frame (e.g., depending on 3A (auto-focus, auto-exposure, auto-white balance) auto-exposure data from the previous frame). In some cases, the minimum threshold and the maximum threshold can be configurable as per one or more image sensor requirements such as, for example and without limitation, bits-per-pixel, black-level, etc. In some cases, the minimum threshold and/or the maximum threshold may be adjusted to effectively trade off between image quality of the output HDR image, and power/memory usage.

In some examples, an image sensor 130 can capture the ME image 304 of a scene. In some cases, where a SE image 302, ME image 304, and LE image 306 are used to generate an output HDR image (such as HDR image 350) of a scene, pixel values of the ME image 304 may generally be expected to contribute to the output HDR image (e.g., the ME image 304 is an anchor image). That is, if the ME image 304 includes pixels which are underexposed or overexposed, those pixels of the ME image 306 will still be fused with corresponding pixels in either the SE image 302 or LE image 306. In such cases, the image sensor 130 may input the captured ME image 304 to a no-op gate 506 of the frontend engine 508B. The no-op gate 506 may perform no operation of the ME image 304 but may be used to align the processing of the ME image 304 with the processing of the SE image 302 and LE image 306 by the corresponding HDR input gates 502. In some cases, the no-op gate 506 may be a memory, such as an output or input register. The no-op gate 506 may input the ME image 302 to one or more frontend modules 310 of frontend engine 508B which can apply one or more pre-processing operations to the ME image 304. In some cases, the one or more pre-processing operations applied in system 500 may be substantially similar to the one or more pre-processing operations applied in system 300. In some cases, after the one or more pre-processing operations are performed, a post pre-preprocessed ME image 304 may be input to no-op gate 510. In some cases, no-op gate 510 may be substantially similar to no-op gate 506. No-op gate 510, in some cases, may be used to align the processing of the ME image 304 with the processing of the SE image 302 and LE image 306 by the corresponding HDR input gates 504. In some examples, the post-preprocessed ME image 304 may be output from no-op gate 510 for image compression 314 and then stored memory 316.

In some cases, the compressed ME image 304 may be loaded from memory 316 and image decompression 322 performed on the compressed ME image 304. The decompressed ME image 304 may be input to no-op gate 516. In some cases, no-op gate 516 may be substantially similar to no-op gate 506. No-op gate 516, in some cases, may be used to align the processing of the ME image 304 with the processing of the SE image 302 and LE image 306 by the corresponding HDR input gates 512. The no-op gate 516 may input the decompressed ME image 304 to one or more image processing (IP) modules 332. In some cases, IP modules 332 of system 500 may be substantially similar to IP modules 332 of system 300. In some cases, after the one or more processing operations of IP modules 332 are performed, a post processed ME image 304 may be input to no-op gate 518. In some cases, no-op gate 518 may be substantially similar to no-op gate 510. No-op gate 518, in some cases, may be used to align the processing of the ME image 304 with the processing of the SE image 302 and LE image 306 by the corresponding HDR output gates 514. No-op gate 518 may input to the HDR fusion engine 340. In some cases, HDR fusion engine 340 of system 500 may combine/merge the decompressed, processed LE image 302, the decompressed, processed ME image 304, and the decompressed, processed LE image 306 into a single, fused HDR image in a manner substantially similar to HDR fusion engine 340 of system 300. The fused HDR image may be input to one or more post fusion modules 342 for post-fusion processing operations. In some cases, the one or more post fusion modules 342 of system 500 may be substantially similar to one or more post fusion modules 342 of system 300. In some cases, after post processing operations, by the HDR fusion engine 340, the image processor 330 may output the HDR image 350.

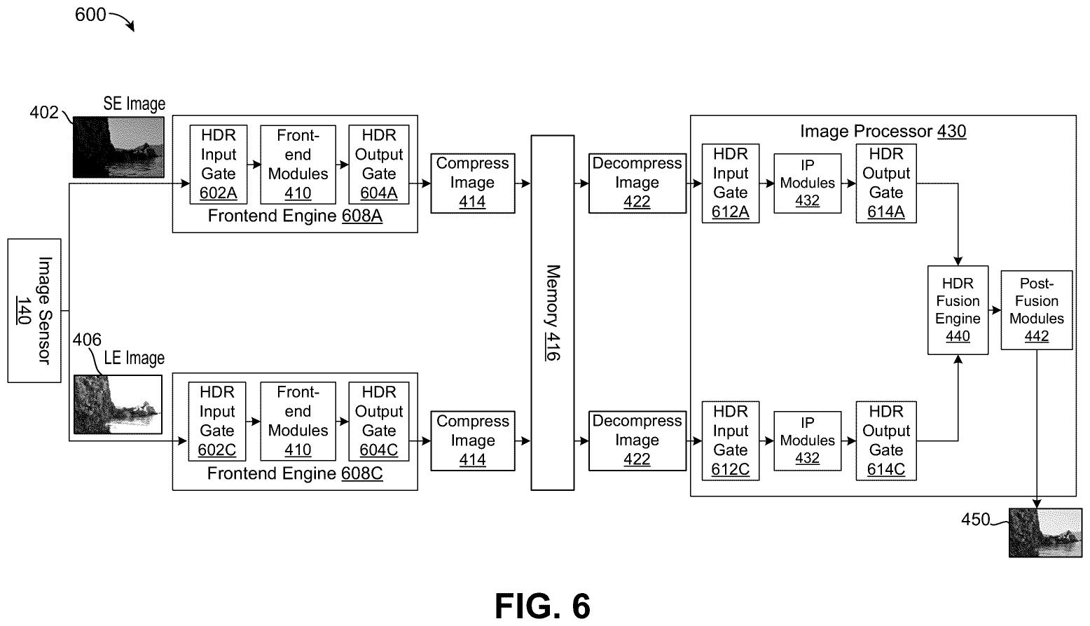

FIG. 6 is a block diagram illustrating an example system 600 for reducing the power and bandwidth used to generate an HDR image, in accordance with aspects of the present disclosure. In this example, the system 600 generates an HDR image 450 using images with two different exposures. As shown, the image sensor 130 can capture an SE image 402 of a scene and an LE image 406 of the scene. In some cases, the system 600 for generating the HDR image 450 using two images is similar to the system 500 for generating the HDR image 350 using three images. In some cases, a difference in the system 600 for generating the HDR image 450 using two as compared to the system 500 for generating the HDR image 350 using three images is that the system 600 for generating the HDR image 450 does not use a medium exposure image. The SE image 402 can include an image with an exposure time below a threshold and the LE image 406 can include an image with an exposure time above a threshold.

In some cases, an image sensor 130 can capture the SE image 402 of a scene and input the captured SE image 402 to the HDR input gate 602A of frontend engine 608A. The HDR input gate 602A may compare pixel values of the input SE image 402 against a minimum threshold value. In some examples, the HDR input gate 602A may compare, in addition to the pixel value of a particular pixel, pixel values of neighboring pixels of the particular pixel.

In some cases, where two exposures are used to generate the HDR image 450, one of the exposures may be used as an anchor image when generating the HDR image 450 and the other image may be a secondary image. As an example, in some cases, the SE image 402 may be the anchor image and the LE image 406 may be the secondary image. In some cases, a more conservative gating may be applied on the anchor image and a more aggressive gating may be applied on the secondary image. For example, pixels in the SE image 402 may be more conservatively gated by using a relatively lower minimum threshold value. Conversely, pixels in the LE image 406 may be more conservatively gated by using a relatively high maximum threshold value. Similarly, pixels in the SE image 402 may be more aggressively gated by using a relatively larger minimum threshold value. Conversely, pixels in the LE image 406 may be more aggressively gated by using a relatively low maximum threshold value. In some cases, anchor images may be applied in examples when there are more than two exposures. For example, a ME image may be used as an anchor image. In some cases, conservative gating may be applied to the anchor image (e.g., SE image, ME image, or LE image) in the form of no gating, or gating based on a relatively low minimum threshold value and/or a relatively high maximum threshold value.

The HDR input gate 602A may input the gated SE image 402 to one or more frontend modules 410 of frontend engine 608A which can apply one or more pre-processing operations to the gated SE image 402. In some cases, the one or more pre-processing operations applied in system 600 may be substantially similar to the one or more pre-processing operations applied in system 400. In some cases, after the one or more pre-processing operations are performed, a post pre-preprocessed SE image 402 may be input to the HDR output gate 604A.

In some cases, the HDR output gate 604A may replace pixel values of pixels gated by the HDR input gate 602A with replacement pixel values in a manner similar to HDR output gate 504A of FIG. 5. The HDR output gate 604A may then output the SE image 402 for image compression 414 and storage in memory 416.

In some cases, the compressed SE image 402 may be loaded from memory 416 and image decompression 422 performed on the compressed SE image 402. The decompressed SE image 402 may be input to HDR input gate 612A. In some cases, HDR input gate 612A may be substantially similar to HDR input gate 602A. The HDR input gate 612A may input the gated, decompressed SE image 402 to one or more image processing (IP) modules 432. In some cases, IP modules 432 of system 600 may be substantially similar to IP modules 432 of system 400. In some cases, after the one or more processing operations of IP modules 432 are performed, a post processed SE image 402 may be input to the HDR output gate 614A. In some cases, the HDR output gate 614A may be substantially similar to HDR output gate 604A. HDR output gate 614A may input to the HDR fusion engine 440. In some cases, HDR fusion engine 440 of system 600 may combine/merge the decompressed, processed SE image 402 and the decompressed, processed LE image 406 into a single, fused HDR image in a manner substantially similar to HDR fusion engine 440 of system 400. The fused HDR image may be input to one or more post fusion modules 442 for post-fusion processing operations. In some cases, the one or more post fusion modules 442 of system 600 may be substantially similar to one or more post fusion modules 442 of system 400. In some cases, after post processing operations, by the HDR fusion engine 440, the image processor 430 may output the HDR image 450.

In some cases, an image sensor 130 can capture the LE image 406 of a scene and input the captured LE image 406 to the HDR input gate 602C of frontend engine 608C. The HDR input gate 602C may compare pixel values of the input LE image 406 against a maximum threshold value. In some examples, the HDR input gate 602C may compare, in addition to the pixel value of a particular pixel, pixel values of neighboring pixels of the particular pixel.

The HDR input gate 602C may input the gated LE image 406 to one or more frontend modules 410 of frontend engine 608C which can apply one or more pre-processing operations to the gated LE image 406. In some cases, the one or more pre-processing operations applied in system 600 may be substantially similar to the one or more pre-processing operations applied in system 400. In some cases, after the one or more pre-processing operations are performed, a post pre-preprocessed LE image 406 may be input to the HDR output gate 604C.

In some cases, the HDR output gate 604C may replace pixel values of pixels gated by the HDR input gate 602C with replacement pixel values in a manner similar to HDR output gate 504C of FIG. 5. The HDR output gate 604C may then output the LE image 406 for image compression 414 and storage in memory 416.

In some cases, the compressed LE image 406 may be loaded from memory 416 and image decompression 422 performed on the compressed LE image 406. The decompressed LE image 406 may be input to HDR input gate 612C. In some cases, HDR input gate 612C may be substantially similar to HDR input gate 602C. The HDR input gate 612C may input the gated, decompressed LE image 406 to one or more image processing (IP) modules 432. In some cases, IP modules 432 of system 600 may be substantially similar to IP modules 432 of system 400. In some cases, after the one or more processing operations of IP modules 432 are performed, a post processed LE image 406 may be input to the HDR output gate 614C. In some cases, the HDR output gate 614C may be substantially similar to HDR output gate 604C. HDR output gate 614C may input to the HDR fusion engine 440. In some cases, HDR fusion engine 440 of system 600 may combine/merge the decompressed, processed LE image 402 and the decompressed, processed LE image 406 into a single, fused HDR image in a manner substantially similar to HDR fusion engine 440 of system 400. The fused HDR image may be input to one or more post fusion modules 442 for post-fusion processing operations. In some cases, the one or more post fusion modules 442 of system 600 may be substantially similar to one or more post fusion modules 442 of system 400. In some cases, after post processing operations, by the HDR fusion engine 440, the image processor 430 may output the HDR image 450.

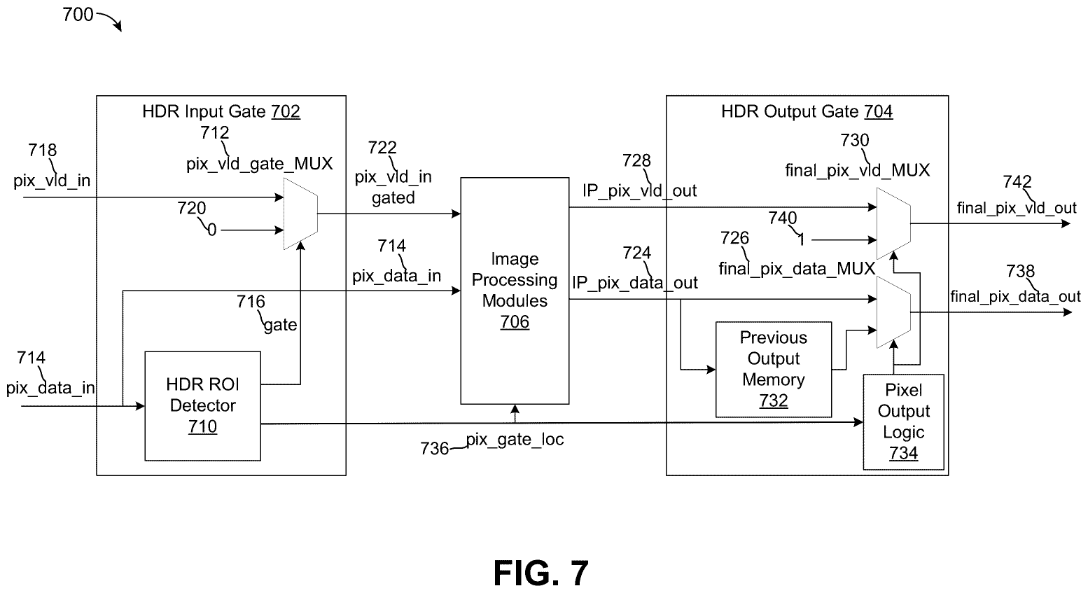

FIG. 7 is a diagram of an example circuit 700 for gating pixel values and processing gated pixel values, in accordance with aspects of the present disclosure. Circuit 700 includes an HDR input gate 702, an HDR output Gate 704, and IP modules 706. In some cases, HDR input gate 702 may correspond to any of HDR input gates 502, 512, 602, and/or 612, HDR output Gate 704 may correspond to any of HDR output gates 504, 514, 604, and/or 614, and IP modules 706 may correspond to any of the one or more frontend modules 310 and/or 410, and/or IP modules 332 and/or 432.

HDR input gate 702 may include an HDR region of interest (ROI) detector 710 and a pixel valid gate multiplexer (pix_vld_gate_MUX) 712. In some cases, pixel data (pix_data_in) 714 may be input, for example, from an image sensor to the HDR ROI detector 710 and the IP modules 706. The HDR ROI detector 710 operates to detect underexposed pixels (e.g., in SE or ME images), pixels in underexposed regions (e.g., based on a M×N region in SE or ME images), overexposed pixels (e.g., in LE or ME images), and/or pixels in overexposed regions (e.g., based on a M×N region in LE or ME images). In some cases, the HDR ROI detector 710 may be configurable to detect underexposed or overexposed pixel or region. Based on whether the HDR ROI detector 710 detects an underexposed or overexposed pixel or region, the HDR ROI detector 710 may send a gate signal 716 to the pixel valid gate multiplexer 712. The HDR ROI detector 710 may also send location information about gated pixels (pix_gate_loc) 736 to the IP modules 706 and pixel output logic 734 of the HDR output gate 704.

The pixel valid gate multiplexer 712 may receive a pixel valid input signal (pix_vld_in) 718 and an invalid signal 720, such as a hardwired 0 signal. If the pixel valid gate multiplexer 712 receives the gate signal 716 for a particular pixel value, the pixel valid gate multiplexer 712 may select the invalid signal 720 for input to the IP modules 706 as a pixel valid/gated value (pix_vld_in gate) 722. The invalid signal 720 indicates to the IP modules 706 to not process the particular pixel/pixel value in the pixel data 714. If the pixel valid gate multiplexer 712 does not receive the gate signal 716 for the particular pixel value, then the pixel valid gate multiplexer 712 may select the pixel valid input signal 718 for input to the IP modules 706 as the pixel valid/gated value 722. The pixel valid input signal 718 may indicate to the IP modules 706 to process the particular pixel/pixel value in the pixel data 714.

The IP modules 706 may then process or not process the particular pixel/pixel value in the pixel data 714 based on the pixel valid/gated value 722. The IP modules 706 may pass any processed pixel data (IP_pix_data_out) 724 (which may not include data if the particular pixel is gated) to a final pixel data mux (final_pix_data_MUX) 726 of the HDR output gate 704. The IP modules 706 may also pass the processed pixel data 724 to a previous output memory 732 of the HDR output gate 704. The IP modules 706 may also indicate which pixels are valid (IP_pix_vld_out) 728, based on the pixel valid/gated value 722, to a final pixel valid mux (final_pix_vld_MUX) 730 of the HDR output gate 704.

In some cases, the HDR output gate 704 may include the final pixel data mux 726, the final pixel valid mux 730, the previous output memory 732, and the pixel output logic 734. The previous output memory 732 may receive and store previous processed pixel data 724 (e.g., a last non-gated processed pixel) output from the IP modules 706. The previous output memory 732 may then input the stored previous processed pixel data 724 to the final pixel data mux 726. The pixel output logic 734 may receive the location information about gated pixels 736 from the HDR ROI detector 710. The location information about gated pixels 736 may indicate locations of gated pixels for an image and the pixel output logic 734 may correlate pixels being input to the final pixel data mux 726 and the final pixel valid mux 730 with the location information about gated pixels 736 to determine when a pixel being input to the final pixel data mux 726 and the final pixel valid mux 730 was gated.

In some cases, if the pixel output logic 734 determines that the pixel was gated, the pixel output logic 734 may signal that the pixel is gated to the final pixel data mux 726 and the final pixel valid mux 730. Based on the signal that the pixel is gated from the pixel output logic 734, the final pixel data mux 726 may select the stored previous processed pixel data 724 from the previous output memory 732 for output as a final pixel data output signal (final_pix_data_out) 738. Similarly, based on the signal that the pixel is gated from the pixel output logic 734, the final pixel valid mux 730 may select an indication that the pixel was gated 740, such as a hardwired 1 signal, for output as the final pixel valid output signal (final_pix_vld_out) 742.

In some cases, if the pixel output logic 734 determines that the pixel was not gated, the pixel output logic 734 may signal that the pixel is not gated to the final pixel data mux 726 and the final pixel valid mux 730. Based on the signal that the pixel is not gated from the pixel output logic 734, the final pixel data mux 726 may select a current processed pixel data 724 from the IP modules 706 for output as the final pixel data output signal 738. Similarly, based on the signal that the pixel is not gated from the pixel output logic 734, the final pixel valid mux 730 may select the pixel valid signal 728 for output as the final pixel valid output signal 742.

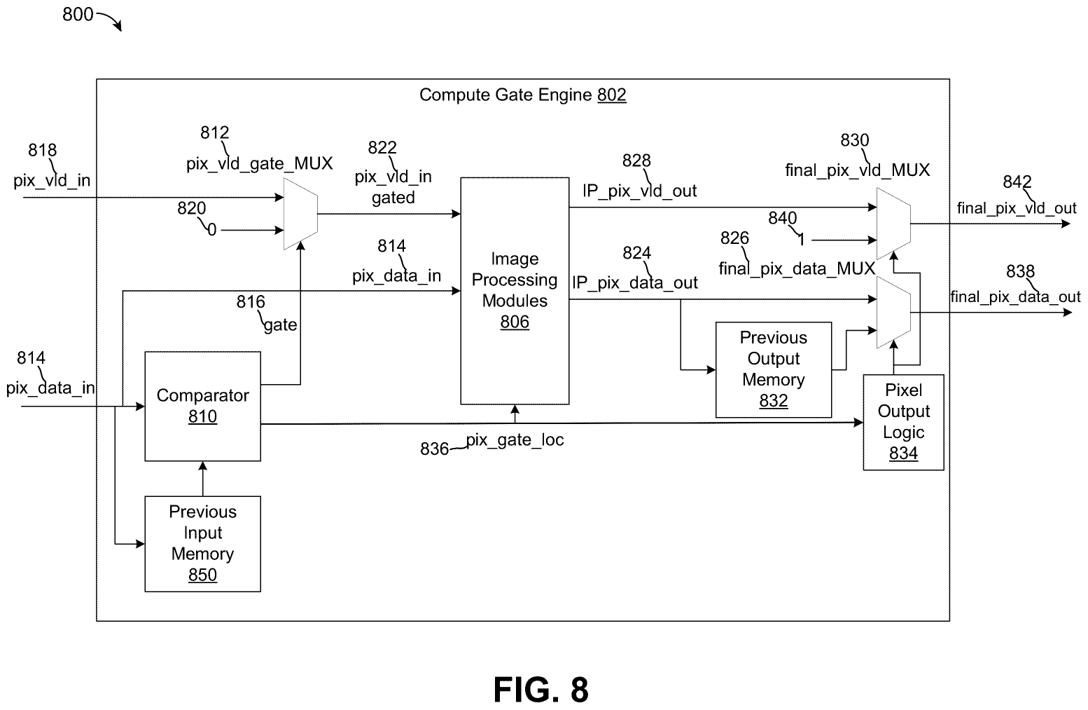

FIG. 8 is a diagram of an example compute gate engine 800 for a configurable pixel value gating and processing, in accordance with aspects of the present disclosure. In some cases, compute gate engine 800 is a variant of circuit 700 with increased flexibility to compare neighboring pixel values. For example, rather than comparing one or more pixels to detect under or over exposed pixels, compute gate engine 800 may compare a pixel or one or more neighboring, previously processed, pixels. Comparing a current pixel to neighboring pixels (e.g., nearby previously processed pixels) may help detect areas in an image that are substantially similar (e.g., having a substantially similar color), and reusing an output of a previous, substantially similar, pixel for the current pixel.

Compute gate engine 800 may include a comparator 810, a previous input memory 850, a pixel valid gate multiplexer (pix_vld_gate_MUX) 812, one or more image processing modules 806, a final pixel data mux (final_pix_data_MUX) 826, a final pixel valid mux 830, a previous output memory 832, and pixel output logic 834. In some cases, the pixel valid gate multiplexer (pix_vld_gate_MUX) 812, final pixel data mux (final_pix_data_MUX) 826, final pixel valid mux 830, previous output memory 832, and pixel output logic 834 operate in a substantially similar manner to the pixel valid gate multiplexer (pix_vld_gate_MUX) 712, final pixel data mux (final_pix_data_MUX) 726, final pixel valid mux 730, previous output memory 732, and pixel output logic 734 of FIG. 7. In some cases, the image processing modules 806 may be any image processing modules, frontend modules, and/or IP modules, and may correspond to any of the one or more frontend modules 310 and/or 410, and/or IP modules 332 and/or 432.

In some cases, pixel data (pix_data_in) 814 may be input, for example, as a pixel stream from an image sensor to the comparator 810, image processing modules 806, and the previous input memory 850. The previous input memory 850 operates to store one or more pixel that were previously processed. The comparator 810 may operate to compare a difference between a current pixel and a previous pixel from the previous input memory 850. In some cases, the comparator may be configured to match a current pixel and a previous pixel if a difference between the current and previous pixel is less than a threshold amount. Expressed as a formula, a match may be found if |Pixel_value_{Current}−Pixel_value_{Previous}|<Pixel_value_{Difference}. In some cases, the threshold amount (e.g., Pixel_value_{Difference}) may be configurable. Additionally, a number, N, of previous pixels to compare with a current pixel may be configurable. For example, the current pixel value may be compared to N previous pixel values and if the current pixel value is within the threshold amount of any of the N previous pixel values, then a match may be found. In some cases, the current pixel value may be compared to a value derived from N previous pixel values. For example, the current pixel value may be compared to an average of N previous pixel values. In some cases, the replacement value may be determined based on an average of N previous pixel values. In some cases, a configurable threshold amount and configurable N number of previous pixel values to compare help allow for a wide rage of trade-offs as between image quality and power.

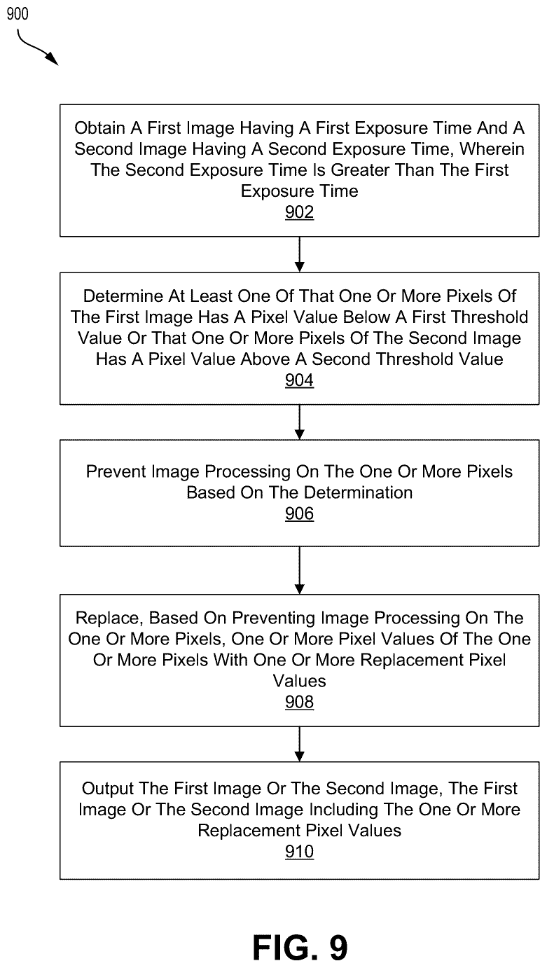

FIG. 9 is a flow diagram for a process 900 for processing image data, in accordance with aspects of the present disclosure. The process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 900 may be implemented as software components that are executed and run on one or more processors.

At block 902 the computing device (or component thereof) may obtain a first image having a first exposure time and a second image having a second exposure time. In some cases, the second exposure time is greater than the first exposure time. In some cases, the one or more pixels of the first image correspond to an underexposed portion of the first image. In some cases, the one or more pixels of the second image correspond to an overexposed portion of the second image.

At block 904 the computing device (or component thereof) may determine at least one of: that one or more pixels of the first image has a pixel value below a first threshold value; or that one or more pixels of the second image has a pixel value above a second threshold value. The computing device (or component thereof) may determine that one or more pixels of the first image has a pixel value below the first threshold value by determining a set of neighboring pixels. The computing device (or component thereof) may further determine that one or more pixels of the first image has a pixel value below the first threshold value by determining that pixel values of the set of neighboring pixels are below the first threshold value. The computing device (or component thereof) may determine both that the one or more pixels of the first image has a pixel value below the first threshold value and that one or more pixels of the second image has a pixel value above the second threshold value. The computing device (or component thereof) may generate a high dynamic range (HDR) image based on the first image and the second image.

At block 906 the computing device (or component thereof) may prevent image processing on the one or more pixels based on the determination. The computing device (or component thereof) may prevent image processing on the one or more pixels by setting an indication that the one or more pixels are gated.

At block 908 the computing device (or component thereof) may replace, based on preventing image processing on the one or more pixels, one or more pixel values of the one or more pixels with one or more replacement pixel values. process pixels of the first image and the second image other than the one or more pixels based on preventing image processing on the one or more pixels. In some cases, the one or more replacement pixel values are based on a pixel value of an additional pixel of the first image or the second image. In some cases, the additional pixel comprises a previously processed pixel. The computing device (or component thereof) may obtain a third image having a third exposure time that is greater than the first exposure time and less than the second exposure time. The computing device (or component thereof) may generate the HDR image by generating the HDR image based on the first image, second image, and the third image.

At block 910 the computing device (or component thereof) may output the first image or the second image, the first image or the second image including the one or more replacement pixel values. The computing device (or component thereof) may generate a high dynamic range (HDR) image based on the first image and the second image. In some cases, the computing device may be a camera device. In some cases, the computing device may be a mobile device.

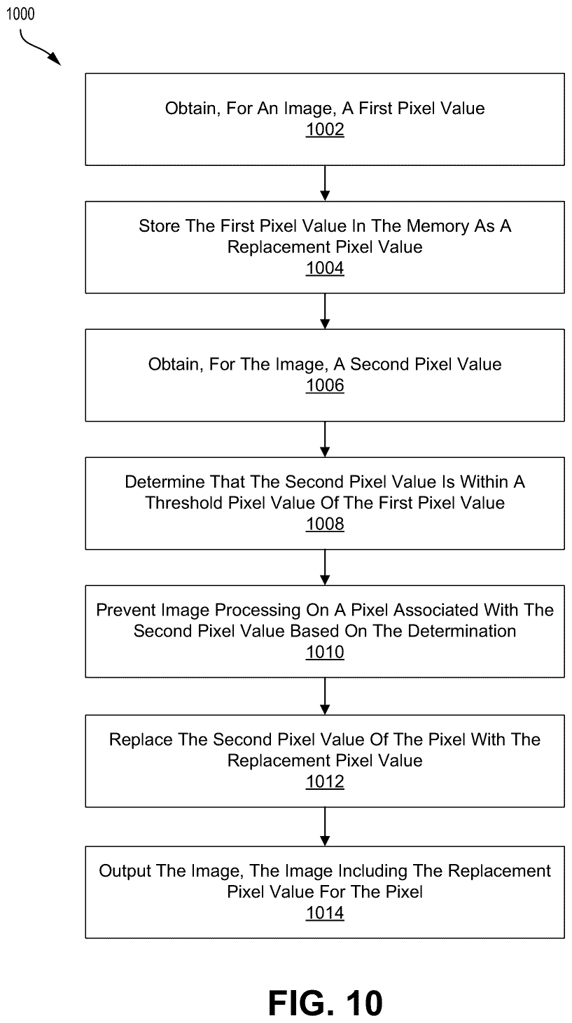

FIG. 10 is a flow diagram 1000 for processing image data, in accordance with aspects of the present disclosure. The process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors.

At block 1002 the computing device (or component thereof) may obtain, for an image, a first pixel value.

At block 1004 the computing device (or component thereof) may store the first pixel value in the memory as a replacement pixel value. The computing device (or component thereof) may obtain, for the image, one or more third pixel values. In some cases, the replacement pixel value is determined based on the first pixel value and the one or more third pixel values. In some cases, the replacement pixel value comprises an average between the first pixel value and the one or more third pixel values.

At block 1006 the computing device (or component thereof) may obtain, for the image, a second pixel value.

At block 1008 the computing device (or component thereof) may determine that the second pixel value is within a threshold pixel value of the first pixel value. In some cases, the threshold pixel value is a configurable value. he computing device (or component thereof) may determine that the second pixel value is within a threshold pixel value of the first pixel value by determining that the second pixel value is within the threshold pixel value of the first pixel value and the one or more third pixel values.

At block 1010 the computing device (or component thereof) may prevent image processing on a pixel associated with the second pixel value based on the determination.

At block 1012 the computing device (or component thereof) may replace the second pixel value of the pixel with the replacement pixel value. The computing device (or component thereof) may process another pixel of the image other than the pixel.

At block 1014 the computing device (or component thereof) may output the image, the image including the replacement pixel value for the pixel.

FIG. 11 illustrates an example computing device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 1100 may include image processing system 100 of FIG. 1. The components of computing device architecture 1100 are shown in electrical communication with each other using connection 1105, such as a bus. The example computing device architecture 1100 includes a processing unit (CPU or processor) 1110 and computing device connection 1105 that couples various computing device components including computing device memory 1115, such as read only memory (ROM) 1120 and random access memory (RAM) 1125, to processor 1110.

Computing device architecture 1100 can include a cache of high-speed memory connected directly with, in close proximity to, or integrated as part of processor 1110. Computing device architecture 1100 can copy data from memory 1115 and/or the storage device 1130 to cache 1112 for quick access by processor 1110. In this way, the cache can provide a performance boost that avoids processor 1110 delays while waiting for data. These and other modules can control or be configured to control processor 1110 to perform various actions. Other computing device memory 1115 may be available for use as well. Memory 1115 can include multiple different types of memory with different performance characteristics. Processor 1110 can include any general purpose processor and a hardware or software service, such as service 1 1132, service 2 1134, and service 3 1136 stored in storage device 1130, configured to control processor 1110 as well as a special-purpose processor where software instructions are incorporated into the processor design. Processor 1110 may be a self-contained system, containing multiple cores or processors, a bus, memory controller, cache, etc. A multi-core processor may be symmetric or asymmetric.

To enable user interaction with the computing device architecture 1100, input device 1145 can represent any number of input mechanisms, such as a microphone for speech, a touch-sensitive screen for gesture or graphical input, keyboard, mouse, motion input, speech and so forth. Output device 1135 can also be one or more of a number of output mechanisms known to those of skill in the art, such as a display, projector, television, speaker device, etc. In some instances, multimodal computing devices can enable a user to provide multiple types of input to communicate with computing device architecture 1100. Communication interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. Storage device 1130 can include services 1132, 1134, 1136 for controlling processor 1110. Other hardware or software modules are contemplated. Storage device 1130 can be connected to the computing device connection 1105. In one aspect, a hardware module that performs a particular function can include the software component stored in a computer-readable medium in connection with the necessary hardware components, such as processor 1110, connection 1105, output device 1135, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for processing image data, the apparatus comprising: a memory: and one or more processors coupled to the memory, the one or more processors are configured to: obtain a first image having a first exposure time and a second image having a second exposure time, wherein the second exposure time is greater than the first exposure time; determine at least one of: that one or more pixels of the first image has a pixel value below a first threshold value; or that one or more pixels of the second image has a pixel value above a second threshold value; prevent image processing on the one or more pixels based on the determination; replace, based on preventing image processing on the one or more pixels, one or more pixel values of the one or more pixels with one or more replacement pixel values; and output the first image or the second image, the first image or the second image including the one or more replacement pixel values.
Aspect 2. The apparatus of Aspect 1, wherein the one or more processors are further configured to process pixels of the first image and the second image other than the one or more pixels based on preventing image processing on the one or more pixels.
Aspect 3. The apparatus of any of Aspects 1-2, wherein the one or more replacement pixel values are based on a pixel value of an additional pixel of the first image or the second image.
Aspect 4. The apparatus of Aspect 3, wherein the additional pixel comprises a previously processed pixel.
Aspect 5. The apparatus of any of Aspects 1-4, wherein, to prevent image processing on the one or more pixels, the one or more processors are further configured to set an indication that the one or more pixels are gated.
Aspect 6. The apparatus of any of Aspects 1-5, wherein, to determine that one or more pixels of the first image has a pixel value below the first threshold value, the one or more processors are further configured to: determine a set of neighboring pixels: and determine that pixel values of the set of neighboring pixels are below the first threshold value.
Aspect 7. The apparatus of any of Aspects 1-6, wherein, to determine that one or more pixels of the second image has a pixel value above the second threshold value, the one or more processors are further configured to: determine a set of neighboring pixels; and determine that pixel values of the set of neighboring pixels are above the second threshold value.
Aspect 8. The apparatus of any of Aspects 1-7, wherein the one or more pixels of the first image correspond to an underexposed portion of the first image, and wherein the one or more pixels of the second image correspond to an overexposed portion of the second image.
Aspect 9. The apparatus of any of Aspects 1-8, wherein the one or more processors are further configured to: generate a high dynamic range (HDR) image based on the first image and the second image.
Aspect 10. The apparatus of any of Aspects 1-9, wherein the one or more processors are configured to: determine both that the one or more pixels of the first image has a pixel value below the first threshold value and that one or more pixels of the second image has a pixel value above the second threshold value; and generate a high dynamic range (HDR) image based on the first image and the second image.
Aspect 11. The apparatus of Aspect 10, wherein the one or more processors are configured to: obtain a third image having a third exposure time that is greater than the first exposure time and less than the second exposure time; wherein, to generate the HDR image, the one or more processors are further configured to generate the HDR image based on the first image, second image, and the third image.
Aspect 12. The apparatus of any of Aspects 1-11, wherein the apparatus comprises a camera device.
Aspect 13. The apparatus of any of Aspects 1-12, wherein the apparatus comprises a mobile device.
Aspect 14. An apparatus for processing image data, the apparatus comprising: a memory; and one or more processors coupled to the memory, the one or more processors are configured to: obtain, for an image, a first pixel value; store the first pixel value in the memory as a replacement pixel value; obtain, for the image, a second pixel value; determine that the second pixel value is within a threshold pixel value of the first pixel value; prevent image processing on a pixel associated with the second pixel value based on the determination; replace the second pixel value of the pixel with the replacement pixel value; and output the image, the image including the replacement pixel value for the pixel.
Aspect 15. The apparatus of Aspect 14, wherein the one or more processors are further configured to process another pixel of the image other than the pixel.
Aspect 16. The apparatus of any of Aspects 14-15, wherein the threshold pixel value is a configurable value.
Aspect 17. The apparatus of any of Aspects 14-16, wherein the one or more processors are further configured to obtain, for the image, one or more third pixel values.
Aspect 18. The apparatus of Aspect 17, wherein the replacement pixel value is determined based on the first pixel value and the one or more third pixel values.
Aspect 19. The apparatus of Aspect 18, wherein the replacement pixel value comprises an average between the first pixel value and the one or more third pixel values.
Aspect 20. The apparatus of Aspect 17, wherein, to determine that the second pixel value is within a threshold pixel value of the first pixel value, the one or more processors are further configured to determine that the second pixel value is within the threshold pixel value of the first pixel value and the one or more third pixel values.
Aspect 21. A method for processing image data, comprising: obtaining a first image having a first exposure time and a second image having a second exposure time, wherein the second exposure time is greater than the first exposure time; determining at least one of: that one or more pixels of the first image has a pixel value below a first threshold value; or that one or more pixels of the second image has a pixel value above a second threshold value; preventing image processing on the one or more pixels based on the determination: replacing, based on preventing image processing on the one or more pixels, one or more pixel values of the one or more pixels with one or more replacement pixel values; and outputting the first image or the second image, the first image or the second image including the one or more replacement pixel values.
Aspect 22. The method of Aspect 21, further comprising processing pixels of the first image and the second image other than the one or more pixels based on preventing image processing on the one or more pixels.
Aspect 23. The method of any of Aspects 21-22, wherein the one or more replacement pixel values are based on a pixel value of an additional pixel of the first image or the second image.
Aspect 24. The method of Aspect 23, wherein the additional pixel comprises a previously processed pixel.
Aspect 25. The method of any of Aspects 21-24, wherein preventing image processing on the one or more pixels comprises setting an indication that the one or more pixels are gated.
Aspect 26. The method of any of Aspects 21-25, wherein the determination that one or more pixels of the first image has a pixel value below the first threshold value comprises determining a set of neighboring pixels: and determining that pixel values of the set of neighboring pixels are below the first threshold value.
Aspect 27. The method of any of Aspects 21-26, wherein the determination that one or more pixels of the second image has a pixel value above the second threshold value comprises determining a set of neighboring pixels; and determining that pixel values of the set of neighboring pixels are above the second threshold value.
Aspect 28. The method of any of Aspects 21-27, wherein the one or more pixels of the first image correspond to an underexposed portion of the first image, and wherein the one or more pixels of the second image correspond to an overexposed portion of the second image.
Aspect 29. The method of any of Aspects 21-28, further comprising generating a high dynamic range (HDR) image based on the first image and the second image.
Aspect 30. The method of any of Aspects 21-29, further comprising: determining both that the one or more pixels of the first image has a pixel value below the first threshold value and that one or more pixels of the second image has a pixel value above the second threshold value; and generating a high dynamic range (HDR) image based on the first image and the second image.
Aspect 31. The method of Aspects 30, further comprising: obtaining a third image having a third exposure time that is greater than the first exposure time and less than the second exposure time; wherein generating the HDR image comprises generating the HDR image based on the first image, second image, and the third image.
Aspect 32. A method for processing image data, comprising: obtaining, for an image, a first pixel value; storing the first pixel value as a replacement pixel value; obtaining, for the image, a second pixel value; determining that the second pixel value is within a threshold pixel value of the first pixel value; preventing image processing on a pixel associated with the second pixel value based on the determination; replacing the second pixel value of the pixel with the replacement pixel value; and outputting the image, the image including the replacement pixel value for the pixel.
Aspect 33. The method of Aspect 32, wherein the threshold pixel value is a configurable value.
Aspect 34. The method of any of Aspects 32-33, further comprising obtaining, for the image, one or more third pixel values.
Aspect 35. The method of Aspect 34, wherein the replacement pixel value is determined based on the first pixel value and the one or more third pixel values.
Aspect 36. The method of Aspect 35, wherein the replacement pixel value comprises an average between the first pixel value and the one or more third pixel values.
Aspect 37. The method of Aspect 32, further comprising processing another pixel of the image other than the pixel.
Aspect 38. The method of Aspect 34, wherein determining that the second pixel value is within a threshold pixel value of the first pixel value comprises determining that the second pixel value is within the threshold pixel value of the first pixel value and the one or more third pixel values.
Aspect 39. A non-transitory computer-readable medium including instructions which, when executed by one or more processors, cause the one or more processors to perform operations according to any of Aspects 21 to 38.
Aspect 28. An apparatus for processing image data, the apparatus comprising one or more means for performing operations according to any of Aspects 21 to 38.

What is claimed is:

1. An apparatus for processing image data, the apparatus comprising:
a memory; and
one or more processors coupled to the memory, the one or more processors are configured to:
obtain a first image having a first exposure time and a second image having a second exposure time, wherein the second exposure time is greater than the first exposure time;
determine at least one of:
that one or more pixels of the first image has a pixel value below a first threshold value; or
that one or more pixels of the second image has a pixel value above a second threshold value;
prevent image processing on the one or more pixels based on the determination;
replace, based on preventing image processing on the one or more pixels, one or more pixel values of the one or more pixels with one or more replacement pixel values; and
output the first image or the second image, the first image or the second image including the one or more replacement pixel values.

2. The apparatus of claim 1, wherein the one or more processors are further configured to process pixels of the first image and the second image other than the one or more pixels based on preventing image processing on the one or more pixels.

3. The apparatus of claim 1, wherein the one or more replacement pixel values are based on a pixel value of an additional pixel of the first image or the second image.

4. The apparatus of claim 3, wherein the additional pixel comprises a previously processed pixel.

5. The apparatus of claim 1, wherein, to prevent image processing on the one or more pixels, the one or more processors are further configured to set an indication that the one or more pixels are gated.

6. The apparatus of claim 1, wherein, to determine that one or more pixels of the first image has a pixel value below the first threshold value, the one or more processors are further configured to:
determine a set of neighboring pixels; and
determine that pixel values of the set of neighboring pixels are below the first threshold value.

7. The apparatus of claim 1, wherein, to determine that one or more pixels of the second image has a pixel value above the second threshold value, the one or more processors are further configured to:
determine a set of neighboring pixels; and
determine that pixel values of the set of neighboring pixels are above the second threshold value.

8. The apparatus of claim 1, wherein the one or more pixels of the first image correspond to an underexposed portion of the first image, and wherein the one or more pixels of the second image correspond to an overexposed portion of the second image.

9. The apparatus of claim 1, wherein the one or more processors are further configured to:
generate a high dynamic range (HDR) image based on the first image and the second image.

10. The apparatus of claim 1, wherein the one or more processors are configured to:
determine both that the one or more pixels of the first image has a pixel value below the first threshold value and that one or more pixels of the second image has a pixel value above the second threshold value; and
generate a high dynamic range (HDR) image based on the first image and the second image.

11. The apparatus of claim 10, wherein the one or more processors are configured to:
obtain a third image having a third exposure time that is greater than the first exposure time and less than the second exposure time;
wherein, to generate the HDR image, the one or more processors are further configured to generate the HDR image based on the first image, second image, and the third image.

12. The apparatus of claim 1, wherein the apparatus comprises a camera device.

13. The apparatus of claim 1, wherein the apparatus comprises a mobile device.

14. An apparatus for processing image data, the apparatus comprising:
a memory; and
one or more processors coupled to the memory, the one or more processors are configured to:
obtain, for an image, a first pixel value;
store the first pixel value in the memory as a replacement pixel value;
obtain, for the image, a second pixel value;
determine that the second pixel value is within a threshold pixel value of the first pixel value;
prevent image processing on a pixel associated with the second pixel value based on the determination;
replace the second pixel value of the pixel with the replacement pixel value; and
output the image, the image including the replacement pixel value for the pixel.

15. The apparatus of claim 14, wherein the one or more processors are further configured to process another pixel of the image other than the pixel.

16. The apparatus of claim 14, wherein the threshold pixel value is a configurable value.

17. The apparatus of claim 14, wherein the one or more processors are further configured to obtain, for the image, one or more third pixel values.

18. The apparatus of claim 17, wherein the replacement pixel value is determined based on the first pixel value and the one or more third pixel values.

19. The apparatus of claim 18, wherein the replacement pixel value comprises an average between the first pixel value and the one or more third pixel values.

20. The apparatus of claim 17, wherein, to determine that the second pixel value is within a threshold pixel value of the first pixel value, the one or more processors are further configured to determine that the second pixel value is within the threshold pixel value of the first pixel value and the one or more third pixel values.

21. A method for processing image data, comprising:
obtaining a first image having a first exposure time and a second image having a second exposure time, wherein the second exposure time is greater than the first exposure time;
determining at least one of:
that one or more pixels of the first image has a pixel value below a first threshold value; or
that one or more pixels of the second image has a pixel value above a second threshold value;
preventing image processing on the one or more pixels based on the determination;
replacing, based on preventing image processing on the one or more pixels, one or more pixel values of the one or more pixels with one or more replacement pixel values; and
outputting the first image or the second image, the first image or the second image including the one or more replacement pixel values.

22. The method of claim 21, further comprising processing pixels of the first image and the second image other than the one or more pixels based on preventing image processing on the one or more pixels.

23. The method of claim 21, wherein the one or more replacement pixel values are based on a pixel value of an additional pixel of the first image or the second image.

24. The method of claim 23, wherein the additional pixel comprises a previously processed pixel.

25. The method of claim 21, wherein preventing image processing on the one or more pixels comprises setting an indication that the one or more pixels are gated.

26. A method for processing image data, comprising:
obtaining, for an image, a first pixel value;
storing the first pixel value as a replacement pixel value;
obtaining, for the image, a second pixel value;
determining that the second pixel value is within a threshold pixel value of the first pixel value;
preventing image processing on a pixel associated with the second pixel value based on the determination;
replacing the second pixel value of the pixel with the replacement pixel value; and
outputting the image, the image including the replacement pixel value for the pixel.

27. The method of claim 26, wherein the threshold pixel value is a configurable value.

28. The method of claim 26, further comprising obtaining, for the image, one or more third pixel values.

29. The method of claim 28, wherein the replacement pixel value is determined based on the first pixel value and the one or more third pixel values.

30. The method of claim 28, wherein the replacement pixel value comprises an average between the first pixel value and the one or more third pixel values.
